(19) United States
(12) Patent Application Publication
(10) Pub. No.: US 2026/0128246 A1
(43) Pub. Date: May 7, 2026

(54) ELECTROMAGNETIC DRIVING UNIT AND RELAY

(71) Applicant: Xiamen Hongfa Electric Power Controls Co., Ltd., Xiamen (CN)

(72) Inventors: Wenguang Dai, Xiamen (CN); Meng Wang, Xiamen (CN); Liji Su, Xiamen (CN)

(21) Appl. No.: 18/993,896

(22) PCT Filed: Jun. 27, 2023
(86) PCT No.: PCT/CN2023/102881

§ 371 Date: Dec. 2, 2025

(30) Foreign Application Priority Data
Jul. 13, 2022 (CN) 202210818439.X

(51) Int. Cl. H01H 50/20; H01H 50/16; H01H 50/36

(52) U.S. Cl. CPC H01H 50/20; H01H 50/163; H01H 50/36

(57) ABSTRACT

An electromagnetic driving unit includes a bobbin having an inner hole; a coil wound on the bobbin; a movable attraction member disposed in the inner hole; and a static attraction member disposed at an end of the inner hole and opposite to the movable attraction member. A plane perpendicular to an axial direction of the inner hole is a projection plane; an orthographic projection area of the movable attraction member on the projection plane is a first projection area; an orthographic projection area of the static attraction member on the projection plane is a second projection area; and the second projection area is larger than the first projection area.

### CROSS REFERENCE

The present disclosure is a national stage of International PCT Application No. PCT/CN2023/102881, filed on Jun. 27, 2023, which claims priority to Chinese Patent Application No. 202210818439. X, filed on Jul. 13, 2022. The content of forgoing applications is incorporated herein by reference in its entirety.

### TECHNICAL FIELD

The present disclosure relates to a field of relay manufacturing and, in particular, to an electromagnetic driving unit and a relay.

### BACKGROUND

A relay is an electronic control device that has a control system (also known as an input loop) and a controlled system (also known as an output loop), and is typically applied to an automatic control circuit. In the circuit, the relay plays a role in automatic regulation, safety protection, circuit switching and so on. With the continuous expansion of usage scenarios of the relay, a high-voltage direct current relay in the related art generally requires characteristics of strong electromagnetic attraction force, low driving power consumption and small volume, and conventional means for enhancing the electromagnetic attraction force in the art is to increase coil winding space and coil driving power of a magnetic circuit part of the relay, but this is contrary to the requirements of low driving power consumption and small volume of the relay. Therefore, how to enhance the electromagnetic attraction force of the relay under the requirements of low driving power consumption and small volume is one of the urgent problems in the art.

### SUMMARY

According to an aspect of the present disclosure, an electromagnetic driving unit includes a bobbin having an inner hole; a coil wound on the bobbin; a movable attraction member disposed in the inner hole; and a static attraction member disposed at an end of the inner hole and opposite to the movable attraction member. A plane perpendicular to an axial direction of the inner hole is a projection plane; an orthographic projection area of the movable attraction member on the projection plane is a first projection area; an orthographic projection area of the static attraction member on the projection plane is a second projection area; and the second projection area is larger than the first projection area.

According to an embodiment of the present disclosure, the static attraction member includes a static iron core, and the static iron core has a radially augmented portion with a radial size larger than a radial size of the movable attraction member; or the static attraction member includes a static iron core and a magnetic conductive ring, and the magnetic conductive ring is sleeved on a periphery of the static iron core.

According to an embodiment of the present disclosure, the static attraction member includes a static iron core and a magnetic conductive ring, the magnetic conductive ring is sleeved on a periphery of the static iron core, and a projection area of the static iron core on the projection plane is consistent with the first projection area of the movable attraction member.

According to an embodiment of the present disclosure, the electromagnetic driving unit further includes a straight line-shaped yoke plate, a U-shaped yoke, and a magnetic conductive cylinder. The yoke plate and the U-shaped yoke are fixedly connected to form a square frame surrounding the coil; the magnetic conductive cylinder is fixedly to the U-shaped yoke and extends towards the yoke plate, and a length of the magnetic conductive cylinder extending towards the yoke plate is less than a height of the U-shaped yoke, to form a space between the magnetic conductive cylinder and the yoke plate; the magnetic conductive cylinder is sleeved on a periphery of the movable attraction member; and the radially augmented portion or the magnetic conductive ring is disposed in the space.

According to an embodiment of the present disclosure, the static iron core is an independent member and is fixedly connected to the yoke plate; or the static iron core and the yoke plate are integrally formed.

According to an embodiment of the present disclosure, the radially augmented portion is a tapered or stepped structure that contracts in a direction towards the movable attraction member or in a direction away from the movable attraction member.

According to an embodiment of the present disclosure, the magnetic conductive ring is a tapered or stepped structure that contracts in a direction towards the movable attraction member or in a direction away from the movable attraction member.

According to an embodiment of the present disclosure, the electromagnetic driving unit further includes a sealing cylinder configured to seal and cover the movable attraction member. A flange is provided at a cylinder opening of the sealing cylinder, the flange abuts against and is fixed on the yoke plate, and the sealing cylinder is provided with a radially outward expanding portion configured to accommodate the radially augmented portion or the magnetic conductive ring.

According to an embodiment of the present disclosure, the electromagnetic driving unit further includes a sealing cylinder configured to seal and cover the movable attraction member. A flange is provided at a cylinder opening of the sealing cylinder, the sealing cylinder is a straight cylinder with equal diameters in each section along an axial direction, and the flange abuts against and is fixed on the radially augmented portion.

According to an embodiment of the present disclosure, the electromagnetic driving unit further includes a sealing cylinder configured to seal and cover the movable attraction member. A flange is provided at a cylinder opening of the sealing cylinder, the sealing cylinder is a straight cylinder with equal diameters in each section along an axial direction, the flange abuts against and is fixed on the yoke plate, and the magnetic conductive ring is sleeved on and fixed on the sealing cylinder.

According to an embodiment of the present disclosure, the movable attraction member is a columnar structure with equal diameters in each section along an axial direction.

According to another aspect of the present disclosure, a relay includes: a contact part for implementing a switching function and an electromagnetic driving unit for driving the contact part of the relay to perform a switching action. The electromagnetic driving unit is the electromagnetic driving unit according to the present disclosure.

### BRIEF DESCRIPTION OF THE DRAWINGS

The above and other features and advantages of the present disclosure will become more apparent by describing in detail exemplary embodiments thereof with reference to the accompanying drawings.

FIG. 1 is a perspective view of Embodiment 1 of an electromagnetic driving unit according to the present disclosure;

FIG. 2 is a sectional view of Embodiment 1 of an electromagnetic driving unit according to the present disclosure;

FIG. 3 is an exploded view of Embodiment 1 of an electromagnetic driving unit according to the present disclosure;

FIG. 4 is a sectional view of Embodiment 2 of an electromagnetic driving unit according to the present disclosure;

FIG. 5 is a sectional view of Embodiment 3 of an electromagnetic driving unit according to the present disclosure;

FIG. 6 is a sectional view of Embodiment 4 of an electromagnetic driving unit according to the present disclosure;

FIG. 7 is a sectional view of Embodiment 5 of an electromagnetic driving unit according to the present disclosure;

FIG. 8 is a sectional view of Embodiment 6 of an electromagnetic driving unit according to the present disclosure;

FIG. 9 is a sectional view of Embodiment 7 of an electromagnetic driving unit according to the present disclosure;

FIG. 10 is a sectional view of Embodiment 8 of an electromagnetic driving unit according to the present disclosure;

FIG. 11 is a sectional view of Embodiment 9 of an electromagnetic driving unit according to the present disclosure;

FIG. 12 is a sectional view of Embodiment 10 of an electromagnetic driving unit according to the present disclosure;

FIG. 13 is a sectional view of Embodiment 11 of the electromagnetic driving unit according to the present disclosure.

### DETAILED DESCRIPTION

Exemplary embodiments will now be described more comprehensively with reference to the accompanying drawings. However, the exemplary embodiments can be implemented in various forms and should not be construed as being limited to the implementations set forth herein. Although relative terms such as “up” and “down” are used in this specification to describe the relative relationship of one marked component to another marked component, these terms are used in this specification for convenience only, for example, according to directions of examples described in the drawings. It can be understood that if a marked device is turned upside down, a component described as being “up” will become a component as being “down”. Other relative terms such as “top” and “bottom” also have similar meanings. When a structure is “on” another structure, it may mean that the structure is integrally formed on the other structure, or that the structure is “directly” disposed on the other structure, or that the structure is “indirectly” disposed on the other structure through another structure.

Terms “one,” “an/a,” “the” and “said” are used to indicate existence of one or more elements/components/the like. Terms “including” and “having” are used in the sense of open-ended inclusion and indicate there may be additional elements/components/the like besides the listed elements/components/the like. Terms such as “first” and “second” are used merely as markers and do not limit the number of the objects referred to.

### Embodiment 1

When applied to a relay, an electromagnetic driving unit is also referred to as a magnetic circuit part, and is used to drive a contact part of the relay to perform a switching action, so as to realize a switching function of the relay.

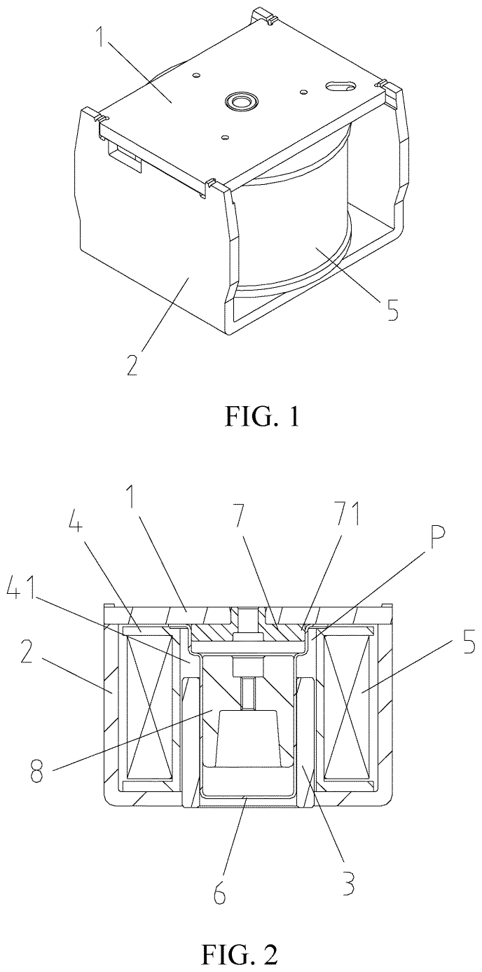

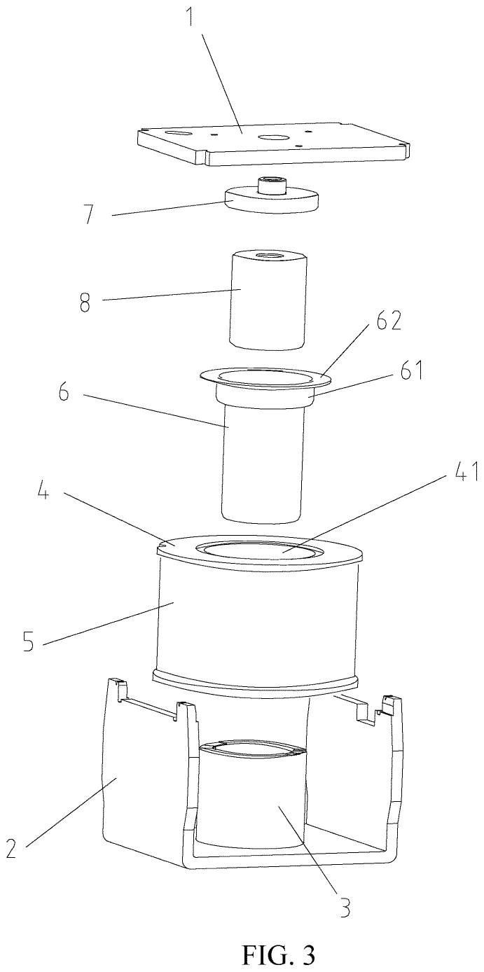

Referring to FIGS. 1-3, the electromagnetic driving unit includes a yoke plate 1, a U-shaped yoke 2, a magnetic conductive cylinder 3, a bobbin 4, a coil 5, a sealing cylinder 6, a static attraction member and a movable attraction member. In this embodiment, the static attraction member is a static iron core 7, and the movable attraction member is a movable iron core 8. The coil 5 is wound on the bobbin 4, the bobbin 4 has an inner hole 41, the movable iron core 8 is slidably disposed in the inner hole 41, and the static iron core 7 is fixedly disposed at an end of the inner hole 41 and opposite to the movable iron core 8. When a current is applied to the coil 5, the static iron core 7 generates an electromagnetic attraction force on the movable iron core 8 to move the movable iron core 8 towards the static iron core 7, thereby generating an actuation action. A counter-force spring (not shown) is disposed between the static iron core 7 and the movable iron core 8 to provide an elastic force for resetting the movable iron core 8. The sealing cylinder 6 is configured to seal and cover the movable iron core 8.

The yoke plate 1 and the U-shaped yoke 2 are fixedly connected to form a square frame yoke and surround a periphery of the coil 5 to enclose magnetic lines of force generated by the coil 5 and enhance the electromagnetic attraction force. The magnetic conductive cylinder 3 is fixed on the U-shaped yoke 2 and extends towards the yoke plate 1. The bobbin 4 is sleeved on the periphery of the magnetic conductive cylinder 3, and the magnetic conductive cylinder 3 is sleeved around the periphery of the movable iron core 8, that is, the movable iron core 8 is also slidably arranged in an inner hole of the magnetic conductive cylinder 3, and further transmission of magnetic lines of force is achieved by the magnetic conductive cylinder 3. A length of the magnetic conductive cylinder 3 extending towards the yoke plate 1 (i.e., a height of the magnetic conductive cylinder 3) is less than a height of the U-shaped yoke 2, and preferably, the height of the magnetic conductive cylinder 3 is between ½ and ⅘ of the height of the U-shaped yoke 2, so that a space P is formed between the magnetic conductive cylinder 3 and the yoke plate 1.

In this embodiment, the movable iron core 8 has a columnar structure with equal diameters in each section along an axial direction, and the static iron core 7 has a radially augmented portion 71 with a radial size larger than a radial size of the movable iron core 8, so that an orthographic projection area (i.e., a second projection area) of the static iron core 7 on a projection plane perpendicular to an axial direction the inner hole 41 is larger than an orthographic projection area (i.e., a first projection area) of the movable iron core 8 on a projection plane perpendicular to the axial direction of the inner hole 41. Since the radially augmented portion 71 increases a diameter of the static iron core 7, leakage magnetic flux in a magnetic circuit can be effectively absorbed, thereby increasing the electromagnetic attraction force of the electromagnetic driving unit.

Additionally, in this embodiment, the radially augmented portion 71 is located in the space P between the magnetic conductive cylinder 3 and the yoke plate 1, and can further absorb the leakage magnetic flux generated due to high reluctance of the space P, thereby reducing magnetic flux loss. Moreover, the radially augmented portion 71 merely utilizes the space P between the magnetic conductive cylinder 3 and the yoke plate 1 fully and effectively, so that an overall volume of the electromagnetic driving unit is not increased on the premise of reducing the magnetic flux loss, achieving two purposes in a single design.

In this embodiment, the radially augmented portion 71 is a columnar structure formed by uniformly augmenting the static iron core 7 in a radial direction thereof to enlarge a radial size of the static iron core 7. In other embodiments, the radially augmented portion 71 may also be irregular and non-uniform, as long as the second projection area of the static iron core 7 on the projection plane perpendicular to the axial direction of the inner hole 41 is larger than the first projection area of the movable iron core 8 on the projection plane perpendicular to the axial direction of the inner hole 41.

In this embodiment, the sealing cylinder 6 includes a flange 62 at a cylinder opening; the flange 62 abuts against and is welded to the yoke plate 1; and in order to accommodate the radially augmented portion 71, the sealing cylinder 6 is further provided with a radially outward expanding portion 61, so that the electromagnetic driving unit has a compact structure.

In this embodiment, through the structural improvement of the static iron core 7, the internal space of the electromagnetic driving unit is effectively utilized, and the electromagnetic attraction force is enhanced while the requirements of low power consumption and small volume of the electromagnetic driving unit are satisfied.

The electromagnetic driving unit provided in this embodiment may be applied to the relay, or may be applied to another electronic component (e.g., an electromagnetic valve) that needs to convert electromagnetic energy into mechanical energy.

### Embodiment 2

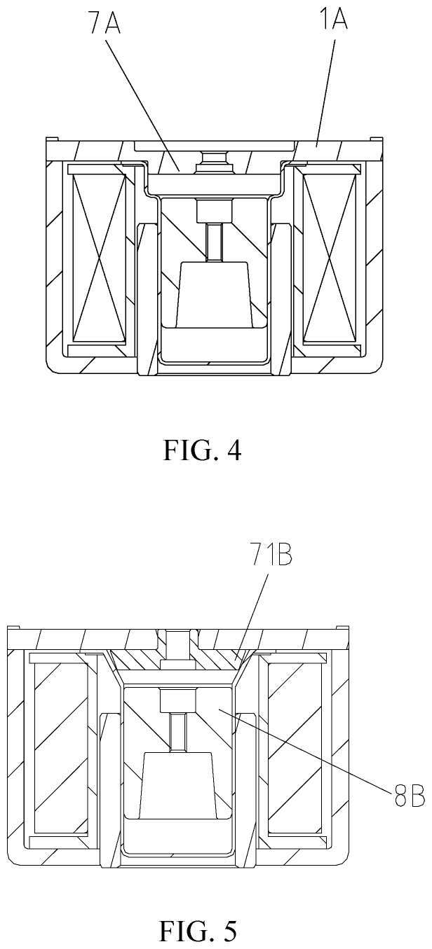

Referring to FIG. 4, an electromagnetic driving unit provided in this embodiment is basically similar to that in Embodiment 1, and has the same technical effect with the same structure, except that: the static iron core 7 and the yoke plate 1 in Embodiment 1 are two independent members and the static iron core 7 is fixedly assembled on the yoke plate 1, but a static iron core 7A and a yoke plate 1A in this embodiment are of an integral structure, and the static iron core 7A is formed by a lower surface of the yoke plate 1A protruding outwards. This embodiment can omit a process of assembling the static iron core 7A and the yoke plate 1A, and hence save costs.

### Embodiment 3

Referring to FIG. 5, an electromagnetic driving unit provided in this embodiment is basically similar to that in Embodiment 1, and has the same technical effect with the same structure, except that: a radially augmented portion 71B of a static iron core in this embodiment is a tapered structure that contracts in a direction towards a movable iron core 8B. This embodiment can reduce the use of material for the static iron core on the premise of absorbing the leakage magnetic flux, so as to lower costs.

### Embodiment 4

Referring to FIG. 6, an electromagnetic driving unit provided in this embodiment is basically similar to that in Embodiment 3, and has the same technical effect with the same structure, except that: a static iron core 7C in this embodiment is integrally formed on a yoke plate 1C. This embodiment can omit a process of assembling the static iron core 7C and the yoke plate 1C, and hence save costs.

### Embodiment 5

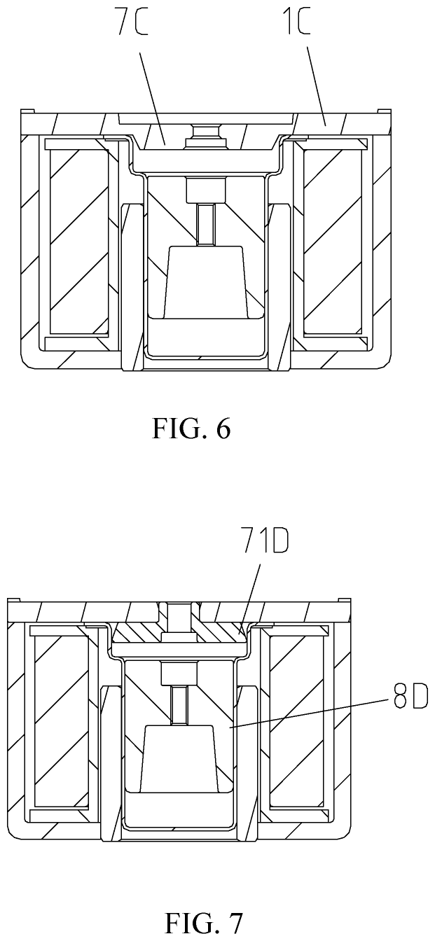

Referring to FIG. 7, an electromagnetic driving unit provided in this embodiment is basically similar to that in Embodiment 1, and has the same technical effect with the same structure, except that: a radially augmented portion 71D of a static iron core in this embodiment is a tapered structure that contracts in a direction away from a movable iron core 8D. This embodiment can reduce the use of material for the static iron core on the premise of absorbing the leakage magnetic flux, so as to lower costs.

### Embodiment 6

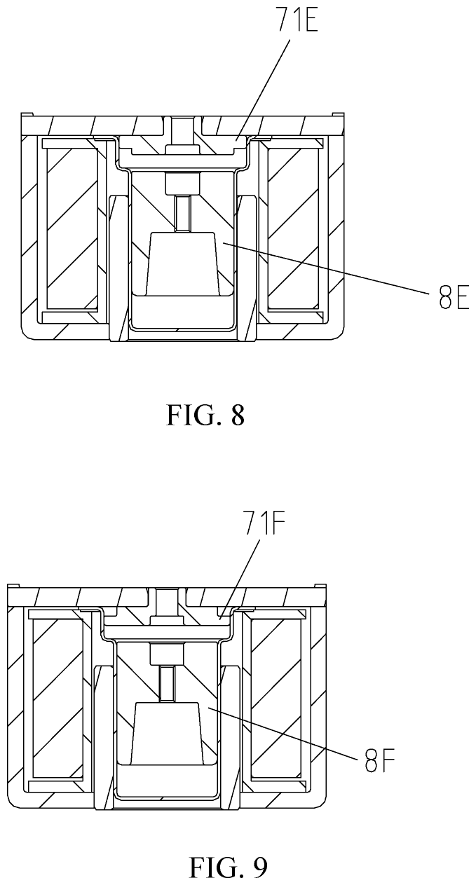

Referring to FIG. 8, an electromagnetic driving unit provided in this embodiment is basically similar to that in Embodiment 1, and has the same technical effect with the same structure, except that: a radially augmented portion 71E of a static iron core in this embodiment is a stepped structure that contracts in a direction towards a movable iron core 8E. This embodiment can reduce the use of material for the static iron core on the premise of absorbing the leakage magnetic flux, so as to lower costs.

### Embodiment 7

Referring to FIG. 9, an electromagnetic driving unit provided in this embodiment is basically similar to that in Embodiment 1, and has the same technical effect with the same structure, except that: a radially augmented portion 71F of a static iron core in this embodiment is a stepped structure that contracts in a direction away from a movable iron core 8F. This embodiment can reduce the use of material for the static iron core on the premise of absorbing the leakage magnetic flux, so as to lower costs.

### Embodiment 8

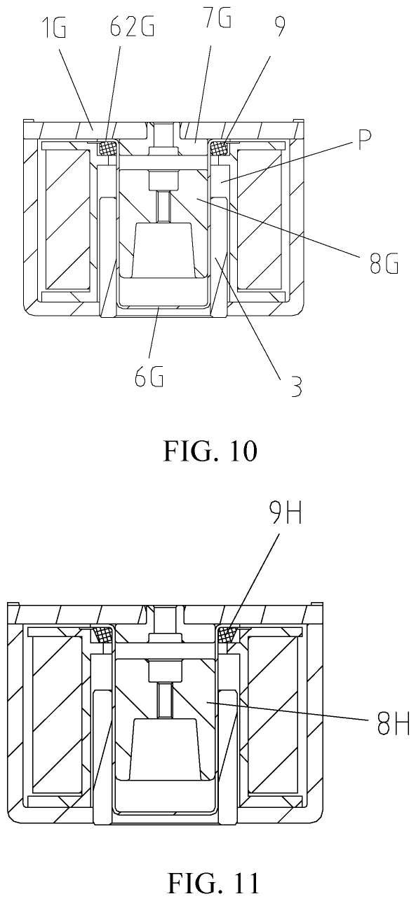

Referring to FIG. 10, an electromagnetic driving unit provided in this embodiment is basically similar to that in Embodiment 1, and has the same technical effect with the same structure, except that: a static attraction member in this embodiment includes two members, namely a static iron core 7G and a magnetic conductive ring 9; a radial size of the static iron core 7G is equal to a radial size of a movable iron core 8G; the magnetic conductive ring 9 is sleeved and fixed on a periphery of the static iron core 7G; and a sum of orthographic projection areas of the static iron core 7G and the magnetic conductive ring 9 on a projection plane perpendicular to an axial direction of an inner hole of a bobbin (i.e., a second projection area of the static attraction member) is larger than a first projection area of the movable iron core 8G on the projection plane perpendicular to the axial direction of the inner hole of the bobbin. The magnetic conductive ring 9 can effectively absorb more magnetic flux leakage and reduce the magnetic flux loss, thereby enhancing the electromagnetic attraction force.

In this embodiment, since the magnetic conductive ring 9 is sleeved on and fixed on the periphery of the static iron core 7G, the assembly and installation of the static attraction member can be more flexible, improving the applicability. In this embodiment, since the radial sizes of the static iron core 7G and the movable iron core 8G are equivalent, the manufacturing and installation can be facilitated. In other embodiments, the radial size of the static iron core 7G may also be slightly smaller than the radial size of the movable iron core 8G, as long as the sum of the orthographic projection areas of the static iron core 7G and the magnetic conductive ring 9 on the projection plane perpendicular to the axial direction of the inner hole of the bobbin (the second projection area) is larger than the orthographic projection area of the movable iron core 8G on the projection plane perpendicular to the axial direction of the inner hole of the bobbin (the first projection area). Similarly, the magnetic conductive ring 9 merely utilizes the space P between the magnetic conductive cylinder 3 and a yoke plate 1G fully and effectively, so that an overall volume of the electromagnetic driving unit is not increased on the premise of reducing the magnetic flux loss.

In Embodiment 8, a sealing cylinder 6G is a straight cylinder with equal diameters in each section along an axial direction, a flange 62G at a cylinder opening of the sealing cylinder 6G abuts against and is fixed on the yoke plate 1G, and the magnetic conductive ring 9 is sleeved on and fixed with the sealing cylinder 6G so as to be sleeved on the periphery of the static iron core 7G. The sealing cylinder 6G in this embodiment has a simpler structure and is easier to manufacture and install, thereby lowering costs.

### Embodiment 9

Referring to FIG. 11, an electromagnetic driving unit provided in this embodiment is basically similar to that in Embodiment 8, and has the same technical effect with the same structure, except that: a magnetic conductive ring 9H in this embodiment is a tapered structure that contracts in a direction towards a movable iron core 8H. This embodiment can reduce the use of material for a static iron core on the premise of absorbing the leakage magnetic flux, so as to lower costs.

In other embodiments, the magnetic conductive ring may also be a tapered structure similar to the radially augmented portion in Embodiment 5, or may also be a stepped structure similar to the radially augmented portion in Embodiments 6 and 7.

### Embodiment 10

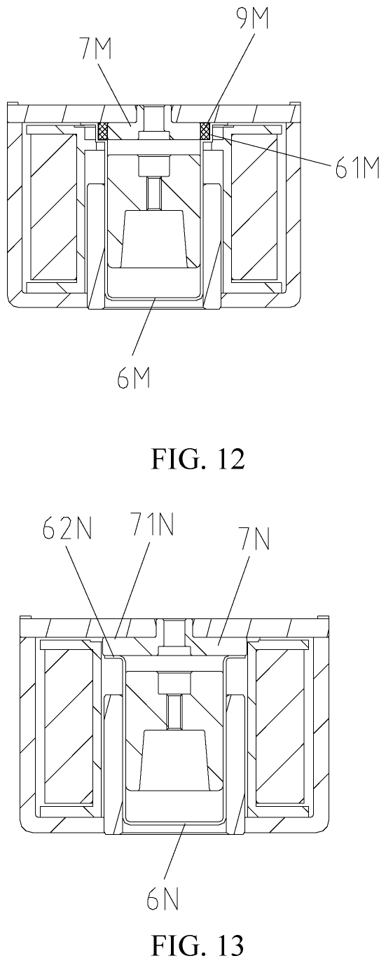

Referring to FIG. 12, an electromagnetic driving unit provided in this embodiment is basically similar to that in Embodiment 8, and has the same technical effect with the same structure, except that: a magnetic conductive ring 9 in Embodiment 8 is specifically sleeved on and fixed with the sealing cylinder 6G, but a magnetic conductive ring 9M in this embodiment is sleeved on and fixed with a static iron core 7M, and a sealing cylinder 6M is provided with a radially outward expanding portion 61M similar to the radially outward expanding portion 61 of the sealing cylinder 6 in Embodiment 1, to accommodate the magnetic conductive ring 9M.

### Embodiment 11

Referring to FIG. 13, an electromagnetic driving unit provided in this embodiment is basically similar to that in Embodiment 1, and has the same technical effect with the same structure, except that: a sealing cylinder 6N in this embodiment is a straight cylinder with equal diameters in each section along an axial direction, and a flange 62N at a cylinder opening of the sealing cylinder 6N abuts against a radially augmented portion 71N of a static iron core 7N. The sealing cylinder 6N in this embodiment has a simpler structure and is easier to manufacture and install, thereby lowering costs.

### Embodiment 12

This embodiment provides a relay, including a contact part for implementing a switching function and an electromagnetic driving unit (or called a magnetic circuit part) for driving the contact part of the relay to perform a switching action. The electromagnetic driving unit is any one of the electromagnetic driving units in Embodiments 1-11 described above, and has equivalent technical effects with the corresponding structure.

The present disclosure has the following beneficial effects. The orthographic projection area of the static attraction member on the projection plane perpendicular to an axis of the inner hole of the bobbin is larger than the orthographic projection area of the movable attraction member on the projection plane perpendicular to the axis of the inner hole of the bobbin, so that the static attraction member can absorb the magnetic flux leakage in the magnetic circuit effectively, thereby enhancing the electromagnetic attraction force of the electromagnetic driving unit.

It should be understood that the present disclosure does not limit its application to the detailed structures and arrangements of components presented herein. The present disclosure may have other embodiments and be realized and performed in a variety of ways. The foregoing variations and modifications fall within the scope of the present disclosure. It should be understood that the present disclosure as disclosed and defined in this specification extends to all alternative combinations of two or more individual features mentioned or apparent in the text and/or in the drawings. All of these various combinations constitute a plurality of alternative aspects of the present disclosure. The embodiments described in this specification elaborate the best ways known for realizing the present disclosure and will enable those skilled in the art to utilize the present disclosure.

1. An electromagnetic driving unit, comprising:
a bobbin having an inner hole;
a coil wound on the bobbin;
a movable attraction member disposed in the inner hole; and
a static attraction member disposed at an end of the inner hole and opposite to the movable attraction member,
wherein a plane perpendicular to an axial direction of the inner hole is a projection plane; an orthographic projection area of the movable attraction member on the projection plane is a first projection area; an orthographic projection area of the static attraction member on the projection plane is a second projection area; and the second projection area is larger than the first projection area.

2. The electromagnetic driving unit according to claim 1, wherein the static attraction member comprises a static iron core, and the static iron core has a radially augmented portion with a radial size larger than a radial size of the movable attraction member; or
the static attraction member comprises a static iron core and a magnetic conductive ring, and the magnetic conductive ring is sleeved on a periphery of the static iron core.

3. The electromagnetic driving unit according to claim 1, wherein the static attraction member comprises a static iron core and a magnetic conductive ring, the magnetic conductive ring is sleeved on a periphery of the static iron core, and a projection area of the static iron core on the projection plane is consistent with the first projection area of the movable attraction member.

4. The electromagnetic driving unit according to claim 2, further comprising
a straight line-shaped yoke plate, a U-shaped yoke, and a magnetic conductive cylinder,
wherein the yoke plate and the U-shaped yoke are fixedly connected to form a square frame surrounding the coil; the magnetic conductive cylinder is fixedly to the U-shaped yoke and extends towards the yoke plate, and a length of the magnetic conductive cylinder extending towards the yoke plate is less than a height of the U-shaped yoke, to form a space between the magnetic conductive cylinder and the yoke plate; the magnetic conductive cylinder is sleeved on a periphery of the movable attraction member; and
the radially augmented portion or the magnetic conductive ring is disposed in the space.

5. The electromagnetic driving unit according to claim 4, wherein
the static iron core is an independent member and is fixedly connected to the yoke plate; or
the static iron core and the yoke plate are integrally formed.

6. The electromagnetic driving unit according to claim 2, wherein the radially augmented portion is a tapered or stepped structure that contracts in a direction towards the movable attraction member or in a direction away from the movable attraction member.

7. The electromagnetic driving unit according to claim 2, wherein the magnetic conductive ring is a tapered or stepped structure that contracts in a direction towards the movable attraction member or in a direction away from the movable attraction member.

8. The electromagnetic driving unit according to claim 4, further comprising a sealing cylinder configured to seal and cover the movable attraction member,
wherein a flange is provided at a cylinder opening of the sealing cylinder, the flange abuts against and is fixed on the yoke plate, and the sealing cylinder is provided with a radially outward expanding portion configured to accommodate the radially augmented portion or the magnetic conductive ring.

9. The electromagnetic driving unit according to claim 4, further comprising a sealing cylinder configured to seal and cover the movable attraction member, wherein a flange is provided at a cylinder opening of the sealing cylinder, the sealing cylinder is a straight cylinder with equal diameters in each section along an axial direction, and the flange abuts against and is fixed on the radially augmented portion.

10. The electromagnetic driving unit according to claim 4, further comprising a sealing cylinder configured to seal and cover the movable attraction member, wherein a flange is provided at a cylinder opening of the sealing cylinder, the sealing cylinder is a straight cylinder with equal diameters in each section along an axial direction, the flange abuts against and is fixed on the yoke plate, and the magnetic conductive ring is sleeved and fixed on the sealing cylinder.

11. The electromagnetic driving unit according to claim 1, wherein the movable attraction member is a columnar structure with equal diameters in each section along an axial direction.

12. A relay comprising a contact part for implementing a switching function and an electromagnetic driving unit for driving a contact part of the relay to perform a switching action, wherein the electromagnetic driving unit comprises:
a bobbin having an inner hole;
a coil wound on the bobbin;
a movable attraction member disposed in the inner hole; and
a static attraction member disposed at an end of the inner hole and opposite to the movable attraction member,
wherein a plane perpendicular to an axial direction of the inner hole is a projection plane; an orthographic projection area of the movable attraction member on the projection plane is a first projection area; an orthographic projection area of the static attraction member on the projection plane is a second projection area; and the second projection area is larger than the first projection area.

13. The relay according to claim 12, wherein the static attraction member comprises a static iron core, and the static iron core has a radially augmented portion with a radial size larger than a radial size of the movable attraction member; or the static attraction member comprises a static iron core and a magnetic conductive ring, and the magnetic conductive ring is sleeved on a periphery of the static iron core.

14. The relay according to claim 12, wherein the static attraction member comprises a static iron core and a magnetic conductive ring, the magnetic conductive ring is sleeved on a periphery of the static iron core, and a projection area of the static iron core on the projection plane is consistent with the first projection area of the movable attraction member.

15. The relay according to claim 13, wherein the electromagnetic driving unit further comprises a straight line-shaped yoke plate, a U-shaped yoke, and a magnetic conductive cylinder,
wherein the yoke plate and the U-shaped yoke are fixedly connected to form a square frame surrounding the coil; the magnetic conductive cylinder is fixedly to the U-shaped yoke and extends towards the yoke plate, and a length of the magnetic conductive cylinder extending towards the yoke plate is less than a height of the U-shaped yoke, to form a space between the magnetic conductive cylinder and the yoke plate;
the magnetic conductive cylinder is sleeved on a periphery of the movable attraction member; and
the radially augmented portion or the magnetic conductive ring is disposed in the space.

16. The relay according to claim 15, wherein
the static iron core is an independent member and is fixedly connected to the yoke plate; or
the static iron core and the yoke plate are integrally formed.

17. The relay according to claim 13, wherein the radially augmented portion is a tapered or stepped structure that contracts in a direction towards the movable attraction member or in a direction away from the movable attraction member.

18. The relay according to claim 13, wherein the magnetic conductive ring is a tapered or stepped structure that contracts in a direction towards the movable attraction member or in a direction away from the movable attraction member.

19. The relay according to claim 15, wherein
the electromagnetic driving unit further comprising a sealing cylinder configured to seal and cover the movable attraction member,
wherein a flange is provided at a cylinder opening of the sealing cylinder, the flange abuts against and is fixed on the yoke plate, and
the sealing cylinder is provided with a radially outward expanding portion configured to accommodate the radially augmented portion or the magnetic conductive ring.
